(19) United States
(12) Patent Application Publication
(10) Pub. No.: US 2025/0383251 A1
(43) Pub. Date: Dec. 18, 2025

(54) MAGNETOSTRICTIVE TORQUE SENSOR

(71) Applicant: Proterial, Ltd., Tokyo (JP)

(72) Inventors: Ken OKUYAMA, Tokyo (JP); Naoki FUTAKUCHI, Tokyo (JP); Teruyuki NAKAMURA, Tokyo (JP)

(73) Assignee: Proterial, Ltd., Tokyo (JP)

(21) Appl. No.: 19/235,143

(22) Filed: Jun. 11, 2025

(30) Foreign Application Priority Data
Jun. 17, 2024 (JP) 2024-097612

(51) Int. Cl. G01L 3/10

(52) U.S. Cl. CPC G01L 3/102

(57) ABSTRACT

A magnetostrictive torque sensor for measuring torque that is applied to a rotating shaft having magnetostrictive characteristics, includes a flexible substrate having a plate-shaped base material made of a flexible dielectric material and a plurality of detection coils formed by conductor patterns on front and back sides of the base material, and a measurement unit that measures the torque by the change in inductance of the plurality of detection coils due to the change in magnetic permeability of the rotating shaft, wherein the plurality of detection coils includes a first detection coil comprising a first coil winding including a first inclined portion inclined to one side with respect to an axial direction of the rotating shaft, and a second detection coil comprising a second coil winding including a second inclined portion inclined to the other side with respect to the axial direction of the rotating shaft, wherein the flexible substrate includes parallel extending portions where the first coil winding and the second coil winding extend parallel to sandwich the substrate, and wherein a centerline of the first coil winding and a centerline of the second coil winding are misaligned in a direction perpendicular to their respective centerlines in the parallel extending portions.

### CROSS-REFERENCE TO RELATED APPLICATIONS

The present patent application claims the priority of Japanese patent application No. 2024-097612 filed on Jun. 17, 2024, and the entire contents thereof are hereby incorporated by reference.

### TECHNICAL FIELD

This invention relates to a magnetostrictive torque sensor for measuring torque that is applied to a rotating shaft having magnetostrictive characteristics.

### BACKGROUND OF THE INVENTION

Conventionally, as a magnetostrictive torque sensor for measuring torque that is applied to a rotating shaft having magnetostrictive characteristics, the applicant of the present application has proposed the torque sensor described in Patent Literature 1. The torque sensor described in Patent Literature 1 includes a flexible substrate having two wiring layers, a first detection coil having a first straight portion inclined at a predetermined angle with respect to the axial direction, and a second detection coil having a second straight portion inclined at a predetermined angle in the direction opposite to the first straight portion with respect to the axial direction. In the magnetostrictive torque sensor described in Patent Literature 1, a part of each of the first detection coil and the second detection coil is formed on one of the two wiring layers, while the other part of each of the first detection coil and the second detection coil is formed on the other one of the two wiring layers, so that the measurement accuracy is improved by suppressing measurement errors caused by characteristic differences between the wiring layers of the flexible substrate. In this configuration, the part of the first detection coil and the other part of the second detection coil are formed on the front and back sides of a base material (e.g., a resin layer) made of a dielectric such as polyimide, and the other part of the first detection coil and the part of the second detection coil are formed on the front and back sides of the base material.

### CITATION LIST

### Patent Literatures

Patent Literature 1: JP6555023B

### SUMMARY OF INVENTION

In the process of working to further improve the accuracy of the magnetostrictive torque sensor, the inventors of the present invention found that the electrostatic capacitance between the coil winding of the first detection coil and the coil winding of the second detection coil, which are placed to sandwich the base material of the flexible substrate, affects the accuracy of torque detection. The present invention was developed based on the finding that the accuracy can be improved by reducing the electrostatic capacitance therebetween. In other words, the object of the present invention is to improve the accuracy of the magnetostrictive torque sensor equipped with the flexible substrate on which multiple detection coils are formed.

For the purpose of solving the above problem, one aspect of the present invention provides a magnetostrictive torque sensor for measuring torque that is applied to a rotating shaft having magnetostrictive characteristics, comprising:
a flexible substrate having a plate-shaped base material made of a flexible dielectric material and a plurality of detection coils formed by conductor patterns on front and back sides of the base material; and
a measurement unit that measures the torque by a change in inductance of the plurality of detection coils due to a change in magnetic permeability of the rotating shaft, wherein the plurality of detection coils includes a first detection coil comprising a first coil winding including a first inclined portion inclined to one side with respect to an axial direction of the rotating shaft, and a second detection coil comprising a second coil winding including a second inclined portion inclined to an other side with respect to the axial direction of the rotating shaft,
wherein the flexible substrate includes parallel extending portions where the first coil winding and the second coil winding extend parallel to sandwich the substrate, and
wherein a centerline of the first coil winding and a centerline of the second coil winding are misaligned in a direction perpendicular to their respective centerlines in the parallel extending portions.

### Advantageous Effects of the Invention

According to the present invention, it is possible to improve the accuracy of a magnetostrictive torque sensor equipped with a flexible substrate on which multiple detection coils are formed.

### BRIEF DESCRIPTION OF DRAWINGS

FIG. 1 is a perspective view showing a magnetostrictive torque sensor together with a rotating shaft to be detected according to an embodiment of the present invention.

FIG. 2 is an exploded perspective view of the magnetostrictive torque sensor.

FIG. 3 is a partial cross-sectional view of a flexible substrate.

FIG. 4 is a circuit diagram schematically showing an example of a circuit configuration of the magnetostrictive torque sensor.

FIG. 5A is a pattern diagram showing a conductor pattern on the front side of a base material on a flexible substrate.

FIG. 5B is a pattern diagram showing a conductor pattern on the back side of the base material.

FIG. 6A is a pattern diagram showing the conductor patterns on the front and back sides overlaid.

FIG. 6B is an enlarged view of part A in FIG. 6A.

FIG. 7A is a plan view showing a first coil winding, a second coil winding, a third coil winding, and a fourth coil winding as seen from the front side of the base material.

FIG. 7B is a cross-sectional view showing the first coil winding, the second coil winding, the third coil winding, and the fourth coil winding in a cross-section perpendicular to their respective directions of extension.

FIG. 8 is a cross-sectional view of the layout configuration of the first coil winding, the second coil winding, the third coil winding, and the fourth coil winding according to a comparative example.

### DETAILED DESCRIPTION OF THE INVENTION

### Embodiment

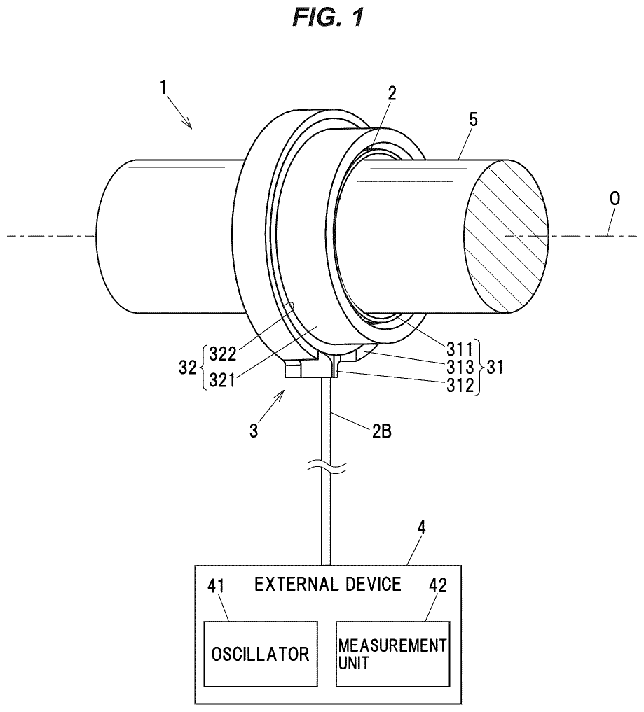

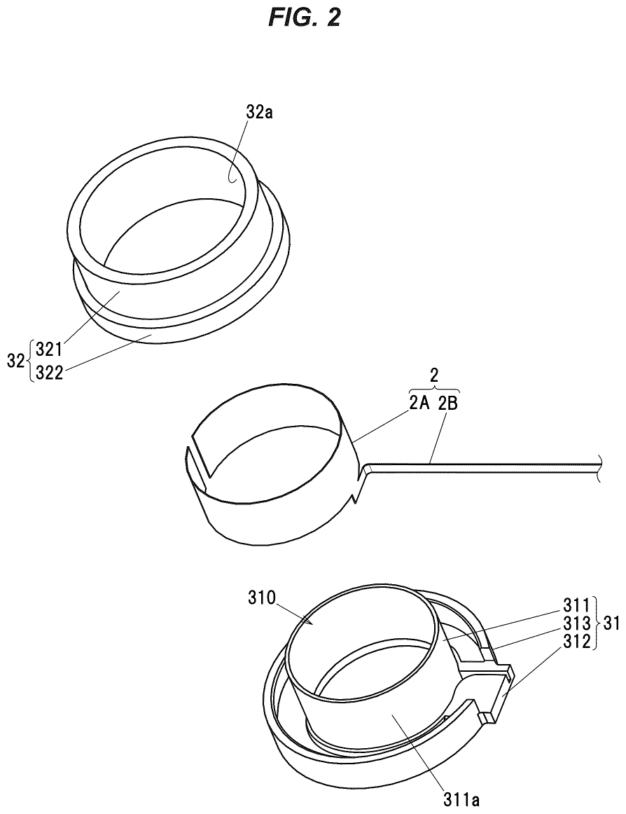

FIG. 1 is a perspective view showing a magnetostrictive torque sensor 1 together with a rotating shaft 5 to be detected according to an embodiment of the present invention. FIG. 2 is an exploded view of the magnetostrictive torque sensor 1.

The magnetostrictive torque sensor 1 is mounted around a rotating shaft 5 and measures the torque applied to the rotating shaft 5. The rotating shaft 5 is a shaft that transmits the driving force of a drive source such as an automobile engine or an electric motor, for example. The torque measurement results obtained by the magnetostrictive torque sensor 1 are used to control the drive source or automatic transmission.

The rotating shaft 5 is a ferromagnetic material having magnetostrictive characteristics, and rotates around a rotation axis line O to transmit torque. The magnetostrictive property here is a property in which distortion (strain) appears in the shape of a ferromagnetic material when a magnetic field is applied to the ferromagnetic material to magnetize it. This characteristic can then be used in reverse to measure the torque applied to the rotating shaft 5 by detecting the change in magnetic properties generated by the shape distortion. As the rotating shaft 5, for example, a shaft-shaped body made of chromium-containing chromium steel such as chrome steel, chrome molybdenum steel, or nickel chrome molybdenum steel, which has been carburized and tempered, and then shot peened, can be suitably used.

The magnetostrictive torque sensor 1 has a flexible substrate 2, a housing 3 that houses the flexible substrate 2, and an external device 4 electrically connected to the flexible substrate 2. The housing 3 has a holder 31 that holds the flexible substrate 2 and a magnetic ring 32 made of a soft magnetic material that is placed around the periphery of the flexible substrate 2. The flexible substrate 2 has a coil formation portion 2A in which a plurality of detection coils, which will be described later, are formed by a conductor pattern, and a linear-shaped lead line portion 2B. The coil formation portion 2A is rectangular in shape. The coil formation portion 2A is arranged around the rotating shaft 5, being curved in the longitudinal direction to follow the rotation direction of the rotating shaft 5.

The holder 31 is made of resin material, such as PPS (polyphenylene sulfide), and is formed by injection molding. The holder 31 integrally comprises a cylindrical portion 311 in which a cavity 310 into which the rotating shaft 5 is inserted is formed at the center, a guide portion 312 protruding radially outward from the cylindrical portion 311 to guide the lead line portion 2B of the flexible substrate 2, and a magnetic ring holding portion 313 that holds the magnetic ring 32 between itself and the cylindrical portion 311. The magnetic ring 32 is made of steel or sintered magnetic material, for example, and has a cylindrical portion 321 whose inner diameter is larger than the outer diameter of the cylindrical portion 311 of the holder 31 and a flange portion 322 that is held by the magnetic ring holding portion 313 of the holder 31.

The external device 4 has an oscillator 41 and a measurement unit 42, and is connected to a plurality of detection coils formed in the coil formation portion 2A via the lead line portion 2B of the flexible substrate 2. The external device 4 and the flexible substrate 2 may be electrically connected by a cable having a plurality of wires. The operation of the external device 4 is described below.

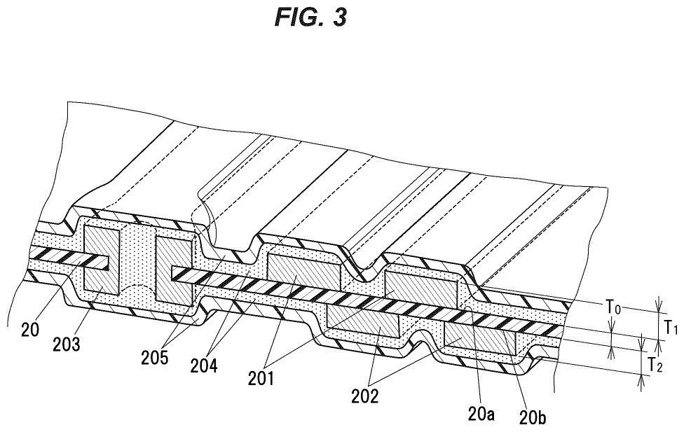

FIG. 3 is a partial cross-sectional view of the flexible substrate 2. The flexible substrate 2 is composed of a plate-shaped base material (base film) 20 made of a flexible dielectric material such as polyimide, a conductor pattern 201 on a front side 20a of the base material 20, a conductor pattern 202 on a back side 20b of the base material 20, a plurality of vias 203 (also referred to as through-holes vias, etc.) connecting the conductor pattern 201 on the front side 20a and a conductor pattern 202 on the back side 20b, and a coverlay 205 bonded by an adhesive 204 to cover the conductor patterns 201, 202 on the front side 20a and the back side 20b.

The conductor patterns 201, 202 are, for example, copper foils, and are formed into a predetermined shape by etching. The flexible substrate 2 is arranged so that the front side 20a of the base material 20 faces an outer circumference surface 311a of the cylindrical portion 311 of the holder 31 and the back side 20b faces an inner circumference surface 32a of the magnetic ring 32. When the thickness of the base material 20 is T₀ and the thicknesses of the conductor patterns 201, 202 are T₁, T₂ respectively, T₀ is formed thinner than T₁, T₂. T₀ is, e.g., 12.5 μm, and T₁, T₂ are, e.g., 20.0 μm, respectively. In FIG. 3, the dimensions in the direction perpendicular to the base material 20 are exaggerated with respect to the dimensions in the direction horizontal to the base material 20.

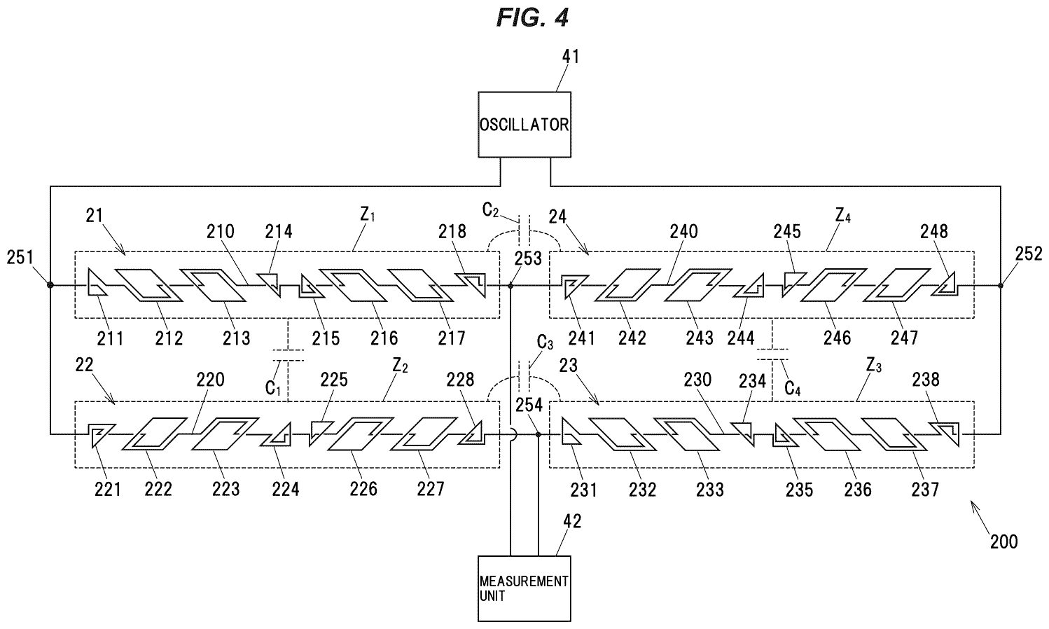

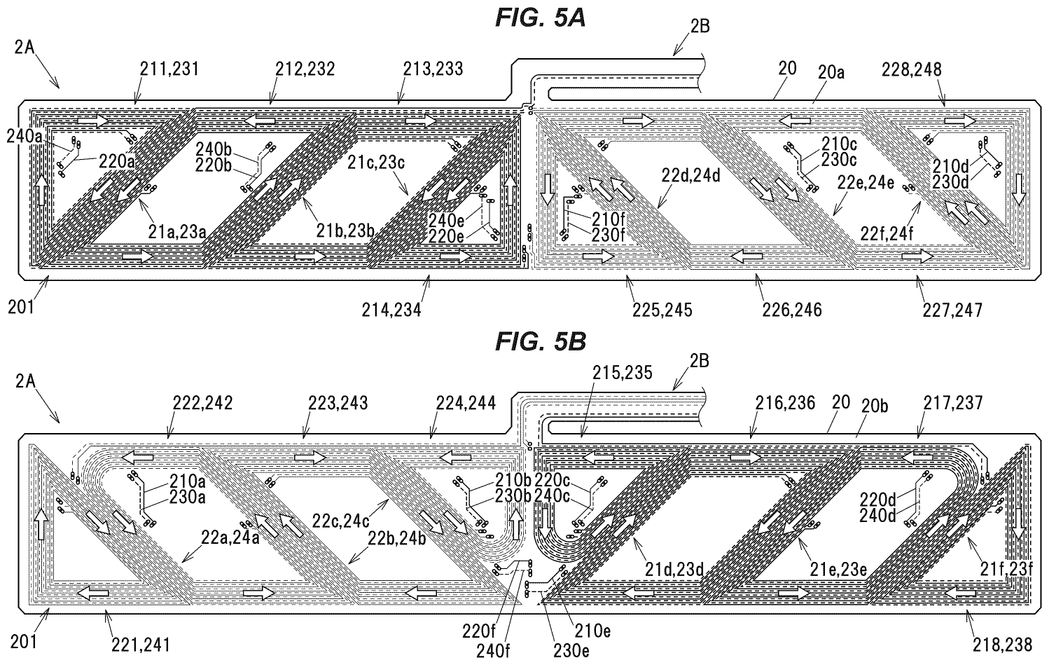

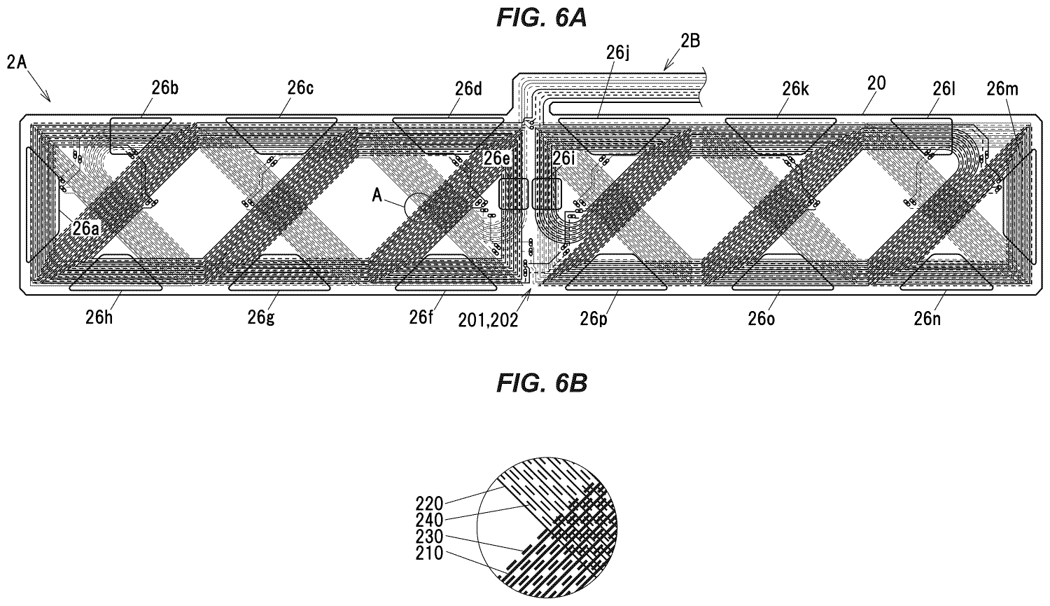

FIG. 4 is a circuit diagram schematically showing an example of a circuit configuration of the magnetostrictive torque sensor 1. FIG. 5A is a pattern diagram showing the conductor pattern 201 on the front side 20a of the base material 20 on the flexible substrate 2. FIG. 5B is a pattern diagram showing the conductor pattern 202 on the back side 20b of the base material 20. FIG. 6A is a pattern diagram showing the conductor patterns 201, 202 on the front and back sides 20a, 20b overlaid. FIG. 6B is an enlarged view of part A in FIG. 6A.

FIGS. 5B, 6A, and 6B show the conductor pattern 202 on the back side 20b of the base material 20 viewed through the base material 20 from the front side 20a. Also, in FIGS. 5A, 5B, 6A, and 6B, the horizontal direction corresponds to the rotation direction of the rotating shaft 5, and the vertical direction corresponds to the axial direction of the rotating shaft 5.

A plurality of detection coils is formed in the coil formation portion 2A of the flexible substrate 2 by the conductor pattern 201 on the front side 20a and the conductor pattern 202 on the back side 20b. In the present embodiment, a first detection coil 21, a second detection coil 22, a third detection coil 23, and a fourth detection coil 24 are formed on the coil formation portion 2A as a plurality of detection coils. In FIGS. 5A, 5B, 6A, and 6B, the first coil winding 210 of the first detection coil 21 is shown as solid black lines, the second coil winding 220 of the second detection coil 22 as solid gray lines, the third coil winding 230 of the third detection coil 23 as dashed black lines, and the fourth coil winding 240 of the fourth detection coil 24 as dashed gray lines.

As shown in FIG. 4, the first detection coil 21, the second detection coil 22, the third detection coil 23, and the fourth detection coil 24 constitute an impedance bridge circuit 200 of Wheatstone bridge type. In FIG. 4, the respective impedances of the first detection coil 21, the second detection coil 22, the third detection coil 23, and the fourth detection coil 24 are represented by Z₁, Z₂, Z₃, and Z₄, respectively. In the impedance bridge circuit 200, the first detection coil 21 and the fourth detection coil 24 are connected in series, while the second detection coil 22 and the third detection coil 23 are connected in series. The first detection coil 21 and the fourth detection coil 24 are connected in parallel with the second detection coils 22 and the third detection coil 23.

In the impedance bridge circuit 200, Z₁ represents the composite impedance of the DC resistance and inductance of the first coil winding 210 of the first detection coil 21. Z₂ represents the composite impedance of the DC resistance and inductance of the second coil winding 220 of the second detection coil 22. Z₃ represents the composite impedance of the DC resistance and inductance of the third coil winding 230 of the third detection coil 23. Z₄ represents the composite impedance of the DC resistance and inductance of the fourth coil winding 240 of the fourth detection coil 24. The DC resistance of the first coil winding 210, the second coil winding 220, the third coil winding 230, and the fourth coil winding 240 is determined by their respective conductor cross-sectional area and length.

The oscillator 41 applies an alternating voltage between a nodal point 251 of the first detection coil 21 and the second detection coil 22 and a nodal point 252 of the fourth detection coil 24 and the third detection coil 23. The measurement unit 42 detects the voltage between a nodal point 253 of the first detection coil 21 and the fourth detection coil 24 and a nodal point 254 of the second detection coil 22 and the third detection coil 23, and measures the torque applied to the rotating shaft 5 based on the detected voltage. In FIGS. 5A and 5B, the direction of the current flowing in each of the first detection coil 21, the second detection coil 22, the third detection coil 23, and the fourth detection coil 24 is indicated by multiple white arrows, in a case where the current flows from the nodal point 251 to the nodal point 252.

The first detection coil 21 has eight coil elements 211 to 218 aligned along the longitudinal direction of the coil formation portion 2A. The coil elements 211 to 218 of the first detection coil 21 are formed by a single first coil winding 210. The first coil winding 210 includes a plurality of first inclined portions 21a to 21f (see FIGS. 5A, 5B) inclined to one side with respect to the axial direction of the rotating shaft 5. These first inclined portions 21a to 21f constitute a part of each of the coil elements 211 to 218 of the first detection coil 21.

The second detection coil 22 has eight coil elements 221 to 228 aligned along the longitudinal direction of the coil formation portion 2A. The coil elements 221 to 228 of the second detection coil 22 are formed by a single second coil winding 220. The second coil winding 220 includes a plurality of second inclined portions 22a to 22f inclined on the other side with respect to the axial direction of the rotating shaft 5. These second inclined portions 22a to 22f comprise a portion of each of the coil elements 221 to 228 of the second detection coil 22.

The third detection coil 23 has eight coil elements 231 to 238 aligned along the longitudinal direction of the coil formation portion 2A. The coil elements 231 to 238 of the third detection coil 23 are formed by a single third coil winding 230. The third coil winding 230 includes a plurality of third inclined portions 23a to 23f inclined to one side with respect to the axial direction of the rotating shaft 5. These third inclined portions 23a to 23f comprise a part of each of the coil elements 231 to 238 of the third detection coil 23.

The fourth detection coil 24 has eight coil elements 241 to 248 aligned along the longitudinal direction of the coil formation portion 2A. The coil elements 241 to 248 of the fourth detection coil 24 are formed by a single fourth coil winding 240. The fourth coil winding 240 includes a plurality of fourth inclined portions 24a to 24f inclined on the other side with respect to the axial direction of the rotating shaft 5. These fourth inclined portions 24a to 24f comprise a part of each of the coil elements 241 to 248 of the fourth detection coil 24.

In the present embodiment, the first inclined portions 21a to 21f of the first detection coil 21 and the third inclined portions 23a to 23f of the third detection coil 23 are straight lines inclined at an angle of 45° to one side with respect to the axial direction of the rotating shaft 5. The second inclined portions 22a to 22f of the second detection coil 22 and the fourth inclined portions 24a to 24f of the fourth detection coil 24 are straight lines inclined at an angle of 45° to the other side with respect to the axial direction of the rotating shaft 5.

When torque is applied to the rotating shaft 5, the magnetic permeability in the direction of +45 degrees to the axial direction decreases (or increases) and the magnetic permeability in the direction of −45 degrees to the axial direction increases (or decreases) due to the magnetostriction effect. Therefore, when torque is applied to the rotating shaft 5 with AC voltage applied from the oscillator 41, the inductance of the first detection coil 21 and the third detection coil 23 decreases (or increases) and the impedance Z₁, Z₃ of the first detection coil 21 and the third detection coil 23 decreases (or increases), while the inductance of the second detection coil 22 and the fourth detection coil 24 increases (or decreases) and the impedances Z₂, Z₄ of the second detection coil 22 and the fourth detection coils 24 increase (or decrease). As a result, the voltage detected by the measurement unit 42 changes, and thus, the torque applied to the rotating shaft 5 can be measured based on this voltage change. In other words, the measurement unit 42 measures the torque applied to the rotating shaft 5 by the change in inductance of the first detection coil 21, the second detection coil 22, the third detection coil 23, and the fourth detection coil 24 due to the change in magnetic permeability of the rotating shaft 5.

In the present embodiment, the first coil winding 210 of the first detection coil 21 and the third coil winding 230 of the third detection coil 23 are formed next to each other at predetermined intervals over the entire coil formation portion 2A, while the second coil winding 220 of the second detection coil 22 and the fourth coil winding 240 of the fourth detection coil 24 are formed next to each other at predetermined intervals throughout the entire coil formation portion 2A.

The first detection coil 21 and the third detection coil 23 are formed on the front side 20a of the base material 20 on one side (left side of FIG. 5A) from the center in the longitudinal direction of the coil formation portion 2A, and are formed on the back side 20b of the base material 20 on the other side (right side of FIG. 5B) from the center in the longitudinal direction. Also, the second detection coil 22 and the fourth detection coil 24 are formed on the back side 20b of the base material 20 on one side (left side of FIG. 5B) from the center in the longitudinal direction of the coil formation portion 2A, and are formed on the front side 20a of the base material 20 on the other side (right side of FIG. 5A) from the center in the longitudinal direction of the coil formation portion 2A.

More specifically, out of the coil elements 211 to 218 of the first detection coil 21 and out of the coil elements 231 to 238 of the third detection coil 23, four coil elements 211 to 214, and 231 to 234 respectively are formed on the front side 20a of the base material 20, while the other four coil elements 215 to 218, and 235 to 238 are formed on the back side 20b of the base material 20. Also, out of the coil elements 221 to 228 of the second detection coil 22 and out of the coil elements 241 to 248 of the fourth detection coil 24, four coil elements 221 to 224, and 241 to 244 respectively are formed on the back side 20b of the base material 20, and the other four coil elements 225 to 228, 245 to 248 are formed on the front side 20a of the base material 20. As a result, even if a difference in DC resistance per unit length arises due to a difference in the line width of the conductor pattern 201 on the front side and the conductor pattern 202 on the back side caused by, for example, a difference in etching conditions between the front side 20a and the back side 20b when manufacturing flexible substrate 2, the effect of the difference in DC resistance on the voltage detected by the measurement unit 42 is suppressed.

In the first coil winding 210 and the third coil winding 230, the connecting portions 210a, 210b, 230a, 230b that connect the coil elements 211 to 214, and 231 to 234 on the front side 20a, are formed on the back side 20b of the base material 20, while the connecting portions 210c, 210d, 230c, 230d that connect the coil elements 215 to 218, 235 to 238 on the back side 20b, are formed on the front side 20a of the base material 20. Also, the connecting portions 210e, 210f, 230e, 230f that connect the coil elements 214, 234 on the front side 20a to the coil elements 215, 235 on the back side 20b, are formed over the front side 20a and the back side 20b of the base material 20. These connecting portions 210a, 210b, 210c, 210d, 210e, 210f, 230a, 230b, 230c, 230d, 230e, and 230f are provided with the vias 203 at both ends each.

In the second coil winding 220 and the fourth coil winding 240, the connecting portions 220a, 220b, 240a, 240b that connect the four coil elements 221 to 224, 241 to 244 on the back side 20b, are formed on the front side 20a of the base material 20, while the connecting portions 220c, 220d, 240c, 240d that connect the four coil elements 225 to 228, and 245 to 248 on the front side 20a, are formed on the back side 20b of the base material 20. Also, the connecting portions 220e, 220f, 240e, 240f that connect the coil elements 224, 244 on the back side 20b to the coil elements 225, 245 on the front side 20a, are formed over the front side 20a and the back side 20b of the base material 20. These connecting portions 220a, 220b, 220c, 220d, 220e, 220f, 240a, 240b, 240c, 240d, 240e, 240f are provided with the vias 203 at both ends each.

In the flexible substrate 2, the first coil winding 210 and the third coil winding 230, and the second coil winding 220 and the fourth coil winding 240, include a plurality of parallel extending portions 26a to 26p which extend parallel to sandwich the base material 20, as shown in FIG. 6A. In FIG. 6A, these parallel extending portions 26a to 26p are shown surrounded by solid lines. In the parallel extending portions 26a to 26p, the first coil winding 210 and the third coil winding 230 are formed parallel to each other on one side of the front side 20a and the back side 20b of the base material 20, and the second coil winding 220 and the fourth coil winding 240 are formed parallel to each other on the other side of the front side 20a and the back side 20b of the base material 20. The parallel extending portions 26a to 26h are located on one side from the center in the longitudinal direction of the coil formation portion 2A, and the parallel extending portions 26i to 26p are located on the other side from the center in the longitudinal direction of the coil formation portion 2A.

Because of the above, electrostatic capacitance can be generated by dielectric polarization in the base material 20 between the first coil winding 210 and the second and fourth coil windings 220, 240, and between the third coil winding 230 and the second and fourth coil windings 220, 240. In FIG. 4, the electrostatic capacitance between the first coil winding 210 and the second coil winding 220, between the first coil winding 210 and the fourth coil winding 240, between the third coil winding 230 and the second coil winding 220, and between the third coil winding 230 and the fourth coil winding 240, are represented by C₁ to C₄ respectively. If these electrostatic capacitances C₁ to C₄ are large, they may affect the voltage detected by the measurement unit 42 and may cause a large error in the torque measurement results.

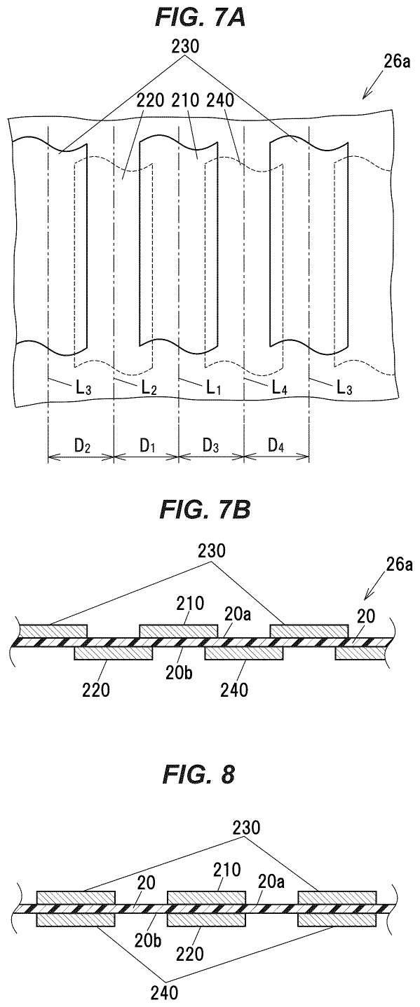

In the present embodiment, as a countermeasure against the above problem, the first coil winding 210 and the third coil winding 230, the second coil winding 220 and the fourth coil winding 240 are shifted in a direction perpendicular to the respective extending portion directions in the parallel extending portions 26a to 26p. Next, this arrangement configuration of the first coil winding 210, second coil winding 220, third coil winding 230, and fourth coil winding 240 will be explained in more detail with reference to FIGS. 7A and 7B, taking one parallel extending portion 26a as an example. In other parallel extending portions 26b to 26p, the arrangement configuration of the first coil winding 210, the second coil winding 220, the third coil winding 230, and the fourth coil winding 240 is similar to that shown in FIGS. 7A and 7B. However, in the parallel extending portions 26i to 26p, which are located on the other side from the center in the longitudinal direction of the coil formation portion 2A, the relationship of the front and back sides of the base material 20 is opposite to that shown in FIGS. 7A and 7B.

FIG. 7A is a plan view showing the first coil winding 210, the second coil winding 220, the third coil winding 230, and the fourth coil winding 240, viewed from the front side 20a of the base material 20. FIG. 7B is a cross-sectional view showing the first coil winding 210, the second coil winding 220, the third coil winding 230, and the fourth coil winding 240 in a cross-section perpendicular to their respective directions of extension. Additionally, in FIG. 7A, the adhesive 204 and the coverlay 205 (see FIG. 3) are omitted.

In FIG. 7A, the both ends of the first coil winding 210 and the third coil winding 230 in the width direction are shown as solid lines, the both ends of the second coil winding 220 and the fourth coil winding 240 in the width direction are shown as dashed lines, centerlines L₁, L₃ of the first coil winding 210 and the third coil winding 230 respectively are shown as dash-dotted lines, and centerlines L₂, L₄ of the second coil winding 220 and the fourth coil winding 240 respectively, are shown as two dotted lines. The centerlines L₁ to L₄ are straight lines bisecting the first coil winding 210, the second coil winding 220, the third coil winding 230, and the fourth coil winding 240 in the respective width directions. The width of the first coil winding 210, the second coil winding 220, the third coil winding 230, and the fourth coil winding 240 is, for example, 120 μm. The spacing between the first coil winding 210 and the third coil winding 230 and the spacing between the second coil winding 220 and the fourth coil winding 240 are, e.g., 80 μm each.

As shown in FIGS. 7A and 7B, the centerline L₁ of the first coil winding 210 and the centerline(s) L₃ of the third coil winding 230, and the centerline L₂ of the second coil winding 220 and the centerline L₄ of the fourth coil winding 240 are misaligned orthogonally (in the left and right directions in FIGS. 7A, 7B) with respect to the respective centerlines L₁ to L₄. When the parallel extending portion 26a is viewed from the direction perpendicular to the base material 20, the centerline L₂ of the second coil winding 220 and the centerline L₄ of the fourth coil winding 240 are in the middle of the centerline L₁ of the first coil winding 210 and the centerline L₃ of the third coil winding 230.

In other words, in the direction perpendicular to the centerlines L₁ to L₄, the distance D₁ between the centerline L₁ of the first coil winding 210 and the centerline L₂ of the second coil winding 220 is equivalent to the distance D₂ between the centerline L₃ of the third coil winding 230 and the centerline L₂ of the second coil winding 220, and the distance D₃ between the centerline L₁ of the first coil winding 210 and the centerline L₄ of the fourth coil winding 240 is equivalent to the distance D₄ between the centerline L₃ of the third coil winding 230 and the centerline L₄ of the fourth coil winding 240. It is desirable that the ratio of the absolute value of the difference between D₁ and D₂ to the sum of D₁ and D₂ (|D₁−D₂)/(D₁+D₂)) be less than 10%, and more desirably 5% or less. Also, it is desirable that the ratio of the absolute value of the difference between D₃ and D₄ to the sum of D₃ and D₄ (|D₃−D₄|/(D₃+D₄)) be 10% or less, and more desirably 5% or less.

FIG. 8 is a cross-sectional view of the layout configuration of the first coil winding 210, the second coil winding 220, the third coil winding 230, and the fourth coil winding 240 according to a comparative example. In the comparative example, the first coil winding 210 and the second coil winding 220 are aligned in the thickness direction of the base material 20 across the base material 20, and the third coil winding 230 and the fourth coil winding 240 are aligned in the thickness direction of the base material 20 across the base material 20.

In the comparative example shown in FIG. 8, the first coil winding 210 and the second coil winding 220, and the third coil winding 230 and the fourth coil winding 240 respectively face each other across the base material 20 in the entire width direction, so the electrostatic capacitance between the first coil winding 210 and the second coil winding 220, and between the third coil winding 230 and the fourth coil winding 240 become larger. Therefore, these electrostatic capacitances may affect the voltage detected by the measurement unit 42, resulting in a larger error in the torque measurement results.

On the other hand, in the present embodiment, the first coil winding 210 and the third coil winding 230, and the second coil winding 220 and the fourth coil winding 240 are misaligned in the direction perpendicular to the direction of their extending portion. Therefore, compared with the configuration of the comparative example, the electrostatic capacitance C₁ between the first coil winding 210 and the second coil winding 220, the electrostatic capacitance C₂ between the first coil winding 210 and the fourth coil winding 240, the electrostatic capacitance C₃ between the third coil winding 230 and the second coil winding 220, and the electrostatic capacitance C₄ between the third coil winding 230 and the fourth coil winding 240 become smaller. This improves the detection accuracy of the magnetostrictive torque sensor 1.

### Summary of Embodiments

Next, the technical concepts that can be grasped from the above embodiments and modifications are described with the help of the characters, etc. in the embodiments and modifications. However, each character in the following description does not limit the components in the scope of claims to the parts, etc. specifically shown in the embodiments.

According to the first feature, the magnetostrictive torque sensor 1 for measuring torque that is applied to a rotating shaft 5 having magnetostrictive characteristics, includes a flexible substrate 2 having a plate-shaped base material 20 made of a flexible dielectric material and a plurality of detection coils 21 to 24 formed by conductor patterns 201, 202 arranged on a front side 20a and a back side 20b of the base material 20; and a measurement unit 42 for measuring the torque by change in the inductance of the plurality of detection coils 21 to 24 due to changes in the magnetic permeability of the rotating shaft 5, wherein the plurality of detection coils 21 to 24 includes a first detection coil 21 including a first coil winding 210 including first inclined portions 21a to 21f that are inclined to one side in the axial direction of the rotating shaft 5, and a second detection coil 22 comprising a second coil winding 220 including second inclined portions 22a to 22f that are inclined to the other side in the axial direction of the rotating shaft 5, wherein the flexible substrate 2 includes parallel extending portions 26a to 26p in which the first coil winding 210 and the second coil winding 220 extend parallel to sandwich the base material 20, and wherein in the parallel extending portions 26a to 26p a centerline L₁ of the first coil winding 210 and a centerline L₂ of the second coil winding are misaligned in the direction perpendicular to their respective centerlines L₁, L₂.

According to the second feature, in the magnetostrictive torque sensor 1 as described by the first feature, the plurality of detection coils 21 to 24 includes, in addition to the first detection coil 21 and the second detection coil 22, a third detection coil 23 including a third coil winding 230 including third inclined portions 23a to 23f that are inclined on one side with respect to the axial direction of the rotating shaft 5 and a fourth detection coil 24 including a fourth coil winding 240 including fourth inclined portions 24a to 24f that are inclined on the other side with respect to the axial direction of the rotating shaft 5, wherein a bridge circuit 200 is composed of the first detection coil 21 and the fourth detection coil 24 connected in series and the second detection coil 22 and the third detection coil 23 connected in series, wherein in the parallel extending portions 26a to 26p, the first coil winding 210 and the third coil winding 230 are formed parallel to each other on one side of the front side 20a and the back side 20b of the base material 20, and the second coil winding 220 and the fourth coil winding 240 are formed parallel to each other on the other side of the front side 20a and the back side 20b of the base material 20, and wherein the centerline L₁ of the first coil winding 210 and the centerline L₃ of the third coil winding 230, and the centerline L₂ of the second coil winding 220 and the centerline L₄ of the fourth coil winding 240 are misaligned in a direction perpendicular to their respective centerlines L₁ to L₄.

According to the third feature, in the magnetostrictive torque sensor 1 as described by the second feature, the first coil winding 210 and the third coil winding 230 are formed next to each other at predetermined intervals, and the second coil winding 220 and the fourth coil winding 240 are formed next to each other at predetermined intervals.

According to the fourth feature, in the magnetostrictive torque sensor 1 as described by the third feature, the centerline L₂ of the second coil winding 220 and the centerline L₄ of the fourth coil winding 240 are located in the middle of the centerline L₁ of the first coil winding 210 and the centerline L₃ of the third coil winding 230, when the parallel extending portions 26a to 26p are viewed from a direction perpendicular to the base material 20.

According to the fifth feature, in the magnetostrictive torque sensor 1 as described by any of 2 to 4, the flexible substrate 2 has a rectangular coil formation portion 2A on which the first detection coil 21, the second detection coil 22, the third detection coil 23, and the fourth detection coil 24 are formed, wherein the coil formation portion 2A is arranged around the rotating shaft 5, being curved in the longitudinal direction to follow the rotation direction of the rotating shaft 5, wherein the first detection coil 21 and the third detection coil 23 are formed on the front side 20a of the base material 20 on one side in the longitudinal direction from the center of the coil formation portion 2A in the longitudinal direction, and formed on the back side 20b of the base material 20 on the other side in the longitudinal direction from the center in the longitudinal direction, and wherein the second detection coil 22 and the fourth detection coil 24 are formed on the back side 20b of the base material 20 on the one side in the longitudinal direction from the center in the longitudinal direction, and are formed on the front side 20a of the base material 20 on the other side in the longitudinal direction from the center in the longitudinal direction.

The above description of the embodiments of the present invention does not limit the invention to the scope of the claims. It should also be noted that not all of the combinations of features described in the embodiments are essential to the means for solving the problems of the invention. In addition, the invention can be implemented with appropriate modifications to the extent that it does not depart from the intent of the invention, for example, the following modifications are possible.

In the above embodiment, the case in which the torque of the rotating shaft 5 is detected by changes in the inductance of the first detection coil 21, the second detection coil 22, the third detection coil 23, and the fourth detection coil 24 is described. However, not limited to this, the measurement unit 42 may be configured to detect the torque of the rotating shaft 5 by changes in the inductance of the first detection coil 21 and the second detection coil 22, for example. When torque is applied to the rotating shaft 5, the magnetic permeability of the rotating shaft 5 changes anisotropically as described above, so the torque of the rotating shaft 5 can also be detected by, for example, connecting the first detection coil 21 and the second detection coil 22 in series and detecting the potential at the nodal point of the first detection coil 21 and the second detection coil 22.

In the above embodiment, the case in which the flexible substrate 2 has two wiring layers, and the first detection coil 21, the second detection coil 22, the third detection coil 23, and the fourth detection coil 24 are formed on the front and back sides of a single base material 20 was described. However, not limited to this, a flexible substrate having four wiring layers may be used to form the first detection coil 21 and the second detection coil 22 in the first and second layers, and form the third detection coil 23 and the fourth detection coil 24 in the third and fourth layers.

In the above embodiment, the case in which the rotating shaft 5 is a shaft transmitting the driving force of an automobile is described as an example, but the magnetostrictive torque sensor of the present invention may be used, for example, to measure steering torque applied to a steering shaft, and may also be used for applications other than automobiles.

1. A magnetostrictive torque sensor for measuring torque that is applied to a rotating shaft having magnetostrictive characteristics, comprising:
a flexible substrate having a plate-shaped base material made of a flexible dielectric material and a plurality of detection coils formed by conductor patterns on front and back sides of the base material; and
a measurement unit that measures the torque by a change in inductance of the plurality of detection coils due to a change in magnetic permeability of the rotating shaft,
wherein the plurality of detection coils includes a first detection coil comprising a first coil winding including a first inclined portion inclined to one side with respect to an axial direction of the rotating shaft, and a second detection coil comprising a second coil winding including a second inclined portion inclined to an other side with respect to the axial direction of the rotating shaft,
wherein the flexible substrate includes parallel extending portions where the first coil winding and the second coil winding extend parallel to sandwich the substrate, and
wherein a centerline of the first coil winding and a centerline of the second coil winding are misaligned in a direction perpendicular to their respective centerlines in the parallel extending portions.

2. The magnetostrictive torque sensor according to claim 1, wherein the plurality of detection coils includes, in addition to the first detection coil and the second detection coil, a third detection coil comprising a third coil winding including a third inclined portion inclined to the one side with respect to the axial direction of the rotating shaft, and a fourth detection coil comprising a fourth coil winding including a fourth inclined portion inclined to the other side with respect to the axial direction of the rotating shaft,
wherein the first detection coil and the fourth detection coil are connected in series, and the second detection coil and the third detection coil are connected in series to configure a bridge circuit,
wherein in the parallel extending portions, the first coil winding and the third coil winding are formed parallel to each other on one side of the front and back sides of the base material, the second coil winding and the fourth coil winding are formed parallel to each other on an other side of the front and back sides of the base material, and
wherein the centerlines of the first coil winding and the third coil winding, and the centerlines of the second coil winding and the fourth coil winding are misaligned in a direction perpendicular to each of the centerlines.

3. The magnetostrictive torque sensor according to claim 2, wherein the first coil winding and the third coil winding are formed next to each other at predetermined intervals, and the second coil winding and the fourth coil winding are formed next to each other at a predetermined interval.

4. The magnetostrictive torque sensor according to claim 3, wherein the centerline of the second coil winding and the centerline of the fourth coil winding are located in a middle of the centerline of the first coil winding and the centerline of the third coil winding, when the parallel extending portions are viewed from a direction perpendicular to the base material.

5. The magnetostrictive torque sensor according to claim 2, wherein the flexible substrate has a rectangular coil formation portion in which the first detection coil, the second detection coil, the third detection coil, and the fourth detection coil are formed; and
wherein the coil formation portion is arranged around the rotating shaft, being curved in a longitudinal direction of the coil formation portion to follow a rotation direction of the rotating shaft,
wherein the first detection coil and the third detection coil are formed on the front side of the base material on one side in the longitudinal direction from the center of the coil formation portion in the longitudinal direction, and on the back side of the base material on the other side in the longitudinal direction from the center of the coil formation portion in the longitudinal direction, and
wherein the second detection coil and fourth detection coil are formed on the back side of the base material on the one side in the longitudinal direction from the center in the longitudinal direction, and are formed on the front side of the base material on the other side in the longitudinal direction from the center in the longitudinal direction.
